(19) United States
(12) Patent Application Publication
(10) Pub. No.: US 2022/0127169 A1
(43) Pub. Date: Apr. 28, 2022

(54) REACTIVE ELECTROCHEMICAL MEMBRANE SYSTEM AND METHODS OF MAKING AND USING

(71) Applicant: University of Georgia Research Foundation, Inc., Athens, GA (US)

(72) Inventors: Qingguo Huang, Fayetteville, GA (US); Huanhuan Shi, Henan (CN); Edward Huang, Fayetteville, GA (US)

(21) Appl. No.: 17/434,909

(22) PCT Filed: Feb. 28, 2020
(86) PCT No.: PCT/US2020/020431

§ 371 Date: Aug. 30, 2021

Related U.S. Application Data
(60) Provisional application No. 62/812,113, filed on Feb. 28, 2019.

(51) Int. Cl. C02F 1/461

(52) U.S. Cl. CPC C02F 1/46109; C02F 2303/04; C02F 2001/46133

(57) ABSTRACT

REM systems for disinfecting water, which includes a tank, a membrane anode, a cathode, and a conductive contactor, is disclosed. The conductive contactor is in direct contact with the membrane anode. The conductive contactor is in electrical communication with the cathode. The REM systems can further contain an inlet and an outlet for supplying water into the tank and removing water out of the tank respectively. The membrane anode includes a carbon-based material. In the most preferred embodiment, the membrane anode includes layers of activated carbon fiber cloth (ACFC). The membrane anode functions as both the anodic electrode that produces electrochemical reaction and the membrane filter. In one preferred embodiment, the membrane anode generates reactive oxygen species from water oxidation reaction that is effective in disinfecting pathogens in water. Methods of making and using the REM systems are also disclosed.

### CROSS-REFERENCE TO RELATED APPLICATION

This application claims priority to and benefit of provisional application U.S. Ser. No. 62/812,113, filed Feb. 28, 2019, which is incorporated herein by reference in its entirety.

### FIELD OF THE INVENTION

The invention is generally directed to a reactive electrochemical membrane system for disinfecting pathogens in liquids such as water. More specifically, the present invention is directed to a reactive electrochemical membrane system containing carbon-based material for disinfecting pathogens in water and other liquids.

### BACKGROUND OF THE INVENTION

Recent data released by World Health Organization show that close to ⅓ of the world population still lacks access to safely managed water in 2015 (WHO. http://www.who.int/gho/mdg/environmental_sustainability/water/en/2017). Waterborne pathogens lead to spread of diseases, a major cause of death among children in developing regions (Ashbolt, Toxicology 2004, 198, 229-238; Ashbolt, Current Environmental Health Reports 2015, 2, 95-106). Many areas around the world, especially in developing countries, lack the infrastructure to provide clean, reliable water, forcing some people to drink unsafe water, which can cause public health risks. As the human population continues to grow, the availability of safe, clean water will become increasingly stringent, and thus new water disinfection technologies that are suitable for use in the developing and rural regions are in particularly urgent demand (Mwabi, et al., Phys. Chem. Earth. 2011, 36, 1120-1128; Schiermeier, Nature 2008, 452, 260-261).

Methods available for disinfection in distributed point-of-use applications are limited. Chemical disinfection methods involve strong oxidative agents like ozone, chlorine, sodium hypochlorite, or chlorine dioxide that are hazardous to sip and handle, making them not feasible for distributed point-of-use applications at rural places, even those in developed countries (Schiermeier, Nature 2008, 452, 260-261). UV treatment is used in limited cases for distributed disinfection applications, but its effectiveness is largely reduced by light dissipation (Racyte, et al., Water Res. 2013, 47, 6395-6405). Solar water disinfection (SODIS) has been adopted in some developing areas for point-of-use treatment, but its performance is highly dependent on the intensity of sunlight and sensitivity of the pathogens (McGuigan, et al., J. Hazard. Mater. 2012, 235-236, 29-46). Chemical disinfection methods have been used in centralized water treatment plants and involve the use of strong oxidative chemicals like ozone, chlorine, sodium hypochlorite or chlorine dioxide in addition to the other conventional physicochemical processes (Kraft, Platin. Met. Rev. 2008, 52, 177-185). One concern associated with these chemical disinfection methods, such as chlorination and ozonation, is the formation of undesired disinfection by-products (DBPs) in treated water that might be carcinogenic (Szczuka, et al., Water Res. 2017, 122, 633-644; Chuang, et al., Environ. Sci. Technol. 2017, 51, 2329-2338; Zhang, et al., Chinese J. Anal. Chem. 2017, 45, 1203-1208). Regardless, these methods cannot be used in many regions of the world because of the lack of appropriate infrastructure (Shannon, et al., Nature 2008, 452, 301-311). Alternative disinfection approaches with DBPs minimized and easy to use are needed, especially for distributed point-of-use applications.

Reactive electrochemical membrane (REM) filtration is an innovative water treatment technique achieved by passing water through a membrane that also act as an anode, thus combining filtration with various electrochemical effects for water disinfection (Huo, et al., Environ Sci Technol 2016, 50, 7641-7649; Liu, et al., Nano Lett 2014, 14, 5603-5608; Vecitis, et al., Environ Sci Technol 2011, 45, 3672-3679). REM does not involve chemical addition, can be easily operated and driven by solar power, making it potentially suitable for point-of-use water disinfection. Currently, only a few membranes have been tested for REM application in water disinfection, e.g., silver nanowire (Wen, et al., Environ. Sci. Technol. 2017, 51, 6395-6403), copper oxides (Huo, et al., Environ Sci Technol 2016, 50, 7641-7649.), and carbon nanotubes (Rahaman, et al., Environ. Sci. Technol. 2012, 46, 1556-1564). These membrane materials however suffer serious limitations, including possible release of toxic ions, such as silver and copper, and unfavorable filtration flow conditions with carbon nanotube filters.

There remains a need for effective REM system for disinfection of pathogens in water that is easy to operate, environmental friendly and with improved performance such as significantly lowered energy consumption, superior disinfection efficiency, high disinfection speed, and reduced fabrication cost. Another desirable feature is the efficient REM operation by solar energy.

Therefore, it is the object of the present invention to provide REM systems with improved performance.

It is another object of the present invention to provide methods of making REM systems with improved performance.

It is yet another object of the present invention to provide methods of using REM systems with improved performance.

### SUMMARY OF THE INVENTION

Reactive electrochemical membrane (REM) systems containing carbon-based material for disinfecting a liquid such as water, as well as methods of making and using thereof, are provided.

The REM systems typically include a tank, a membrane anode, a cathode, and a conductive contactor. The conductive contactor is typically in direct contact with the membrane anode. The conductive contactor is typically in electrical communication with the cathode. The REM systems can further contain an inlet and an outlet for supplying liquid into the tank and removing liquid out of the tank respectively. In some preferred embodiments, the membrane anode includes a carbon-based material. In the most preferred embodiments, the membrane anode includes layers of activated carbon fiber cloth (ACFC). The membrane anode functions as both the anodic electrode that produces electrochemical reaction and the membrane filter. In some preferred embodiments, the membrane anode generates reactive oxygen species from oxidation of the liquid, such as water oxidation reaction, that is effective in disinfecting pathogens in the liquid.

Also provided are methods of making REM systems that include a tank, a membrane anode, a cathode, and a conductive contactor. For example, the REM systems can made by: (1) placing a membrane anode in a tank; (2) placing a cathode in the tank at a position separated from the membrane anode; (3) placing a conductive contactor in the tank at a position in contact with the membrane anode.

The REM systems disclosed herein can be utilized for disinfecting liquids such as water. Methods of disinfecting liquids such as water can contains one or more of the steps of: (a) introducing a liquid such as water through the inlet of a reactive electrochemical membrane system; (b) passing the liquid through the membrane anode; and (c) removing the disinfected liquid through the outlet. The reactive electrochemical membrane system can include a tank into which liquid is introduced; a membrane anode in the tank which includes a carbon-based material; a cathode in the tank; and a conductive contactor. Typically, the conductive contactor is in contact with the membrane anode, and the conductive contactor is in electrical communication with the cathode. The disclosed REM systems can be utilized as portable systems for disinfecting liquids such as water. The REM systems can be powered by, but not limited to, a power supply, a potentiostat, or solar energy.

### BRIEF DESCRIPTION OF THE DRAWINGS

FIG. 1A is a schematic diagram of a REM system and illustrates how it operates. FIG. 1B is a picture of ACFC.

FIGS. 2A-2C are bar graphs of bacterial log reduction by REM treatment under different conditions. FIG. 2A shows different ACFC layers at 10 V voltage and 10 mL/min flow rate. FIG. 2B shows different voltages with 4 ACFC layers and 10 mL/min flow rate. FIG. 2C shows different flow rates with 4 ACFC layers and at 10 V voltage. The initial E. coli concentration was 10^{7.5}, 10^{7.3}, and 10^{6.7} CFU/mL for the tests in A, B and C, respectively.

FIG. 3 is a bar graph of bacterial Log reduction by REM treatment with 4 or 8 ACFC layers at 10 mL/min and 10 V for continuous operation.

FIG. 4 shows a bar graph of unit energy consumption (UEC) of REM under different operation conditions with 4 ACFC layers.

FIG. 5A shows a graph of the anodic potential vs. standard hydrogen electrode (SHE) (V) at different voltages. FIG. 5B shows a graph of current at different anodic potential vs. SHE (V) measured by linear scan voltammetry of ACFC in 50 mM Na₂SO₄ solution at the scanning rate of 50 mV s⁻¹.

FIG. 6 is a graph showing the loss of terephthalic acid (TA) in 30 mL, of a 50 mM Na₂SO₄ solution with MMO grid as the anode or MMO grid with four ACFC layers as the anode, respectively. Error bars represent standard deviations (n=3). C₀=10 μM, Voltage=10 V.

FIGS. 7A-7B are SEM images of ACFC from REM after passing E. coli solution (˜10⁴ CFU/mL) in 50 mM Na₂SO₄ solution at 10 mL/min with no voltage (FIG. 7A) or 10 V (FIG. 7B) applied.

### DETAILED DESCRIPTION OF THE INVENTION

### I. Definitions

As used herein, the term “activated carbon material” refers to a form of carbon processed to have small pores that increase the surface area available for adsorption or chemical reactions.

As used herein, the term “anode” refers to an electrode that accepts electrons and forms an electrical circuit with the cathode.

As used herein, the term “activated carbon material” when used or referenced in combination with “anode”, “anodic electrode” or “membrane anode” refers to an anode containing a carbon-based material that (a) filters liquid (e.g., water) and/or (b) performs liquid (e.g., water) oxidation reaction. The terms “anode”, “anodic electrode” and “membrane anode” are used interchangeably throughout the instant disclosure.

As used herein, the term “cathode” refers to an electrode that delivers electrons and forms an electrical circuit with the anode.

As used herein, the term “conductive contactor” refers to a substance capable of conducting an electric current and used to pass power to the membrane anode. The conductive contactor can be organic or inorganic in nature as long as it is able to conduct electrons through the material. The conductive contactor can be a polymeric conductor, a metallic conductor, a semiconductor, a carbon-based material, a metal oxide, or a modified conductor.

As used herein, the term “electrolytes” refers to ions, atoms, or molecules that have host or gained electrons, and is electrically conductive.

As used herein, the term “improved performance” in connection with the REM system disclosed herein includes lowered energy consumption, increased disinfection efficiency, and/or increased disinfection speed. As used herein, the term “reactive oxygen species” or “ROS” refers to chemically reactive chemical species containing oxygen. The terms “reactive oxygen species” and “ROS” are used interchangeably throughout the instant disclosure.

As used herein, the term “reference electrode” refers to an electrode that has a well-characterized electrode potential which is stable and well-known. A reference electrode is used to measure or maintain the electrochemical potential of a selected electrode.

As used herein, the term “room temperature” refers to a temperature between about 20° C. and about 25° C. under atmospheric pressure. As used herein, the term “unit energy consumption” refers to the energy consumption per unit volume per log reduction of pathogens.

### II. Reactive Electrochemical Membrane System

Activated carbon fiber cloth (ACFC) is a form of processed carbon that is hydrophobic and porous, allowing it to adsorb bacteria (Prajapati, et al., Chemosphere 2016, 155, 62-69). In addition, ACFC is conductive, and environmentally safe. The Examples below demonstrate for the first time the use of an carbon-based material i.e., activated carbon fiber cloth (ACFC) as the membrane anode in a reactive electrochemical membrane (REM) system to disinfect pathogens in water using non-pathogenic E. coli as a model bacterium. This effective REM system is easy to operate, environmental friendly, and displays improved performance such as lowered energy consumption, superior disinfection efficiency, high disinfection speed, and low fabrication cost. The extremely low energy consumption make it operable with solar energy.

The disclosed REM systems facilitate liquid (e.g., water) disinfection via passing liquid through a membrane anode. The REM systems typically include a tank or well or case, a membrane anode, a cathode, and a conductive contactor. In some embodiments, the membrane anode, the cathode, and the conductive contactor are housed in a single compartment within the same tank or in separate compartments within the same tank. In some embodiments, the membrane anode and the cathode are in the same compartment within the tank and placed apart to avoid shorts.

In some embodiments, separators are included in the REM system to keep a distance between the membrane anode and the cathode. The separator can be any suitable shape, such as disk-shaped, ring-shaped, square, rectangular, etc. In some embodiments, the distance between the membrane anode and the cathode is between 1 cm and 50 cm, between 1 cm and 20 cm, between 1 cm and 10 cm, or between 1 cm and 5 cm inclusive, such as 1.5 cm, for example, in a bench top device such as the one exemplified below. However, this distance can be scaled up or down based on the size of the tank, the anode, the cathode, etc. It is believed that the larger the distance between the membrane anode and the cathode is, the more power would be consumed, while the disinfection effect may be stronger.

The separators can be made of non-conductive materials. In some embodiments, the separators are made of rubber.

The conductive contactor and the membrane anode are typically in direct contact with each other. The conductive contactor is in electrical communication with the cathode. In some embodiments, the conductive contactor, the membrane anode, and the cathode are arranged in parallel to each other.

In some embodiments, a port located on the tank is included in the REM system to serve as an inlet for supplying liquid into the tank. Another port located at a site apart from the inlet on the tank can be included in the REM system to serve as an outlet for removing liquid from the tank after the liquid passes through the membrane anode.

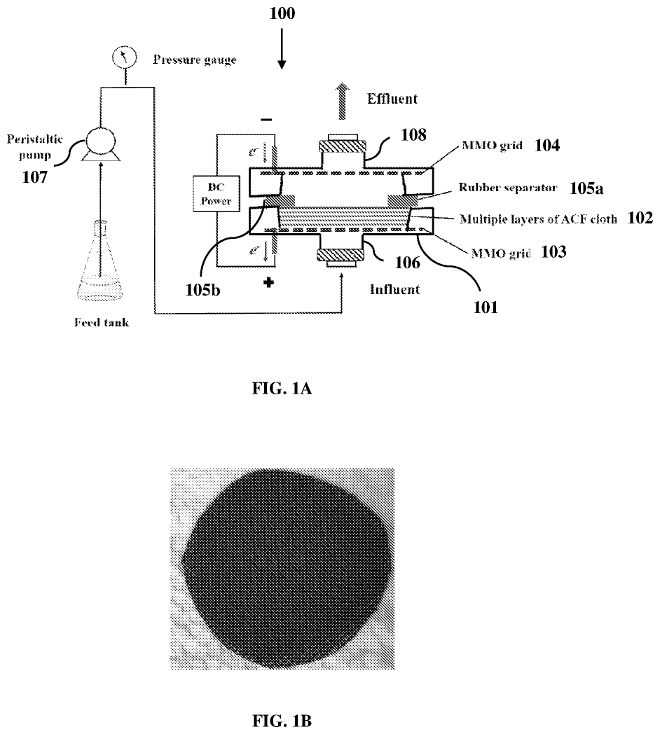

In the most preferred embodiments, the REM system has a configuration generally as shown in FIG. 1A. The exemplary REM system 100 shown in FIG. 1A contains a tank 101, a membrane anode 102, a cathode 104, and a conductive contactor 103. Separators 105a and 105b are included in the REM system to keep a distance between the membrane anode 102 and the cathode 104. A first port 106 is located at the bottom of the tank 101 to supply liquid (e.g., water) into the tank. A second port 108 is located at the top of the tank 101, through which liquid is removed from the tank after passing through the membrane anode 102.

Optionally, a pump is arranged to supply the liquid (e.g., water) into the tank (see, for example, FIG. 1A, 107).

In some embodiments, the membrane anode serves as both the anodic electrode that produces electrochemical reaction and a membrane filter. The membrane anode can be a porous membrane to contain a plurality of pores with pore diameter between 1 nm and 1 mm inclusive in diameter to achieve micro- or ultrafiltration. In some embodiments, the pores are designed to allow some or all microbes to pass through. In such embodiments, the pores may be, for example, greater than 0.1 microns, greater than 0.2 microns, greater than 0.5 microns, greater than 1 micron, greater than 10 microns, greater than 25 microns, greater than 100 microns, etc. In some embodiments, the pores are designed to trap, prevent, or otherwise slow or reduced pass through of some or all microbes. In such embodiments, the pores may be, for example, less than about 25 microns, less than about 10 microns, less than 1 microns, less than about 0.5 microns, less than about 0.2 microns, less than 0.1 microns, etc. For example, ZORFLEX®, the activated carbon mesh used in the Examples below has micropores with a diameter of 4 nm. Thus, in some embodiments the pore has a diameter between about 1 nm and 100 nm, or 1 nm and 50 nm, or 1 nm and 25 nm, or 1 nm and 10 nm inclusive.

The pores can be homogeneous (i.e., having the same diameters) or heterogeneous in size (i.e. having different diameters).

The membrane anode can retain pathogens presented in the liquid (e.g., water) by the filtering effect when the liquid passes through the membrane anode. In some embodiments, the liquid is introduced into the tank at a flow rate between 0.1 mL/min and 10,000 mL/min inclusive, or any sub-range there between or any specific flow rate between rounded to the nearest tenth. For example, in some embodiments, the flow rate is between 0.1 mL/min and 9,000 mL/min, between 0.1 mL/min and 8,000 mL/min, between 0.1 mL/min and 7,000 mL/min, between 0.1 mL/min and 6,000 mL/min, between 0.1 mL/min and 5,000 mL/min, between 0.1 mL/min and 4,000 mL/min, between 0.1 mL/min and 3,000 mL/min, between 0.1 mL/min and 2,000 mL/min, between 0.1 mL/min and 1,000 mL/min, between 0.1 mL/min and 900 mL/min, between 0.1 mL/min and 800 mL/min, between 0.1 mL/min and 700 mL/min, between 0.1 mL/min and 600 mL/min, between 0.1 mL/min and 500 mL/min, between 0.1 mL/min and 400 mL/min, between 0.1 mL/min and 300 mL/min, between 0.1 mL/min and 200 mL/min, between 0.1 mL/min and 100 mL/min, between 10 mL/min and 2,000 mL/min, between 10 mL/min and 1,000 mL/min, between 10 mL/min and 500 mL/min, between 1 mL/min and 200 mL/min, between 1 mL/min and 500 mL/min, between 1 mL/min and 1,000 mL/min, between 1 mL/min and 2,000 mL/min, between 1 mL/min and 5000 mL/min, between 1 mL/min and 10,000 mL/min, between 0.1 mL/min and 20 mL/min, between 1 mL/min and 20 mL/min, between 0.1 mL/min and 15 mL/min, between 1 mL/min and 15 mL/min, between 0.1 mL/min and 10 mL/min, between 1 mL/min and 100 mL/min, or between 1 mL/min and 10 mL/min, inclusive. In some embodiments, the flow rate is between 10 mL/min and 2,000 mL/min, 1 mL/min and 100 mL/min, 1 mL/min and 20 mL/min or between 1 mL/min and 10 mL/min inclusive. In a particular embodiment, the liquid is introduced into the tank at flow rate of 10 mL/min. These flow rates are based on a bench top system such as the one exemplified below. The flow rates can be scaled up or down based on the size of the tank, the anode, the cathode, etc. In some embodiments, preferably the flow rate is sufficient to maximize microbial reduction relative to lower or higher flow rates. In some embodiments, the flow rate of liquid does not reduce the disinfecting ability of the system relative to a lower flow rate, such as a flow rate between 1 mL/min and 10 mL/min. In some embodiments, the flow rate of liquid may reduce the disinfecting ability of the system relative to a lower flow rate, such as between 10 mL/min and 20 mL/min. For example, a flow rate of 20 mL/min may result a 3.2 log reduction in the disinfection performance compared to a flow rate of 10 mL/min.

In some embodiments, the flow rate is as high as possible without substantially reducing the antimicrobial activity of the system.

A voltage is applied between the conductive contactor that is typically in direct contact with the membrane anode and the cathode, resulting in the oxidation of liquid (e.g., water) that produces reactive oxygen species (ROS). Exemplary ROS includes but not limited to peroxides, superoxide, hydroxyl radical, singlet oxygen, alpha-oxygen, and ozone. The ROS generated from liquid oxidation may contain a single species or a mixture of two or more species. In a preferred embodiment, the ROS generated from liquid oxidation contain hydroxyl radicals.

In some embodiments, the voltage applied is measured versus a reference electrode placed at a distance from the membrane anode between 0.1 mm to 10 cm. In some embodiments, the reference electrode is Ag/AgCl(sat. KCl) or standard hydrogen electrode (SHE). In preferred embodiments, the voltage applied between the conductive contactor and the cathode is at least 1 V, 2 V, 3 V, 4 V, 5 V, 6 V, 7 V, 8 V, 9 V, or 10 V, such as between 1 V and 20 V, between 1 V and 10 V, between 2 V and 20 V, between 2 V and 10 V, or between 5 V and 15 V, inclusive. In some embodiments, the voltage applied between the conductive contactor and the cathode is at least 2 V to drive the liquid (e.g., water:) oxidation reaction. The voltage can be scaled up or down based on the size of the tank, the anode, the cathode, etc. In some embodiments, the voltage does not exceed about 20, 30, 40 or 50 volts, particularly for a bench top system such as the one exemplified below. The Examples below show that increasing voltage from 2 V or at least 10 V increases microbial reduction. Thus, preferably the voltage is sufficient to maximize microbial reduction relative to lower voltages.

The voltage can be provided by an external power supply instrument or a potentiostat which is an electrochemical instrument to control a three electrode electrochemical cell. The three electrodes refer to the membrane anode, cathode, and reference electrode. A potentiostat can be used to hold the electrochemical potential of a chosen electrode steady at a selected value relative to the reference electrode positioned near the electrode being controlled.

Microbes, including pathogens can be reduced by the filtration effect of the membrane anode, the ROS generated by liquid oxidation at the membrane anode, or a combination thereof.

In some embodiments, additional electrolytes are added into the liquid to increase conductivity of the liquid. Optionally, reactants that can generate ROS by chemical reaction is added into a REM system to provide additional ROS. ROS generating reactants are known in the art, see, for example, Collin, Int. J. Mol. Sci., 20(10):2407 (2019).

The disclosed REM system shows superior disinfection efficiency, i.e., a reduction of up to 7.5 log unit of microbe such as bacteria in disinfected water. The performance of the REM system is stable for at least 4 hours under continuous operation with water passing through the membrane anode without membrane fouling, i.e., no significant bacteria growth occurs on the membrane anode within 4h of operation. In some embodiments, the disclosed REM system can treat 1.5 L of water that is estimated to be daily consumption of drinking water for an adult within 1.5 minutes. The REM can operate at room temperature for disinfecting water, and it can also be operated at temperatures below room temperature.

Although typically discussed herein with reference to water, it will be appreciated that other liquids, particularly aqueous liquids, can also be disinfected using the disclosed systems, and such other liquids are expressly disclosed and can be substituted for water throughout the disclosure herein where water is specifically mentioned. Likewise, water is a preferred example of a liquid, and can be substituted for liquid throughout the disclosure herein wherein liquid is mentioned.

Additionally, the disclosed REM system advantageously displays extremely low energy consumption (i.e., less than 2 kWh/L). For example, the system has an energy consumption less than 1.5 kWh/L, less than 1 kWh/L, less than 0.5 kWh/L, less than 0.1 kWh/L, less than 0.05 kWh/L, less than 0.01 kWh/L, less than 0.005 kWh/L, less than 0.004 kWh/L, less than 0.003 kWh/L, less than 0.0025 kWh/L, or less than 0.002 kWh/L to achieve at least 2 log units reduction of a living microbes, such as E. coli. By selecting materials for the membrane anode and operation conditions as disclosed herein a REM system employing the disclosed components have demonstrated significantly lowered energy consumption as low as 0.0015 kWh/L. At least 2.2 kWh/L energy was required for above 2 log units reduction of E. coli in previous report (Racyte, et al., Water Res. 2013, 47, 6395-6405). The disclosed REM system can be powered by solar energy.

A. Tank or Case

In some embodiments, the REM systems includes one or more flasks as a tank housing a membrane anode, a cathode, and a conductive contactor within the same tank and arranged in parallel to each other. The tank can have any suitable shape. The tank is typically a receptacle or storage chamber suitable to hold or protect the other components and facilitate their use for liquid disinfection. The tank can also be, and referred to as, a case or well.

The tank and electrode design of the REM system is not limited to the designs disclosed herein. In some embodiments, there is no separating material between the membrane anode and the cathode. In some embodiments, there are separators included in the REM system to keep a distance between the membrane anode and the cathode. In some embodiments, the distance between the membrane anode and the cathode is between 1 and 50 cm, between 1 and 20 cm, between 1 and 10 cm, or between 1 and 5 cm, such as 1.5 cm inclusive, for example, in a bench top device such as the one exemplified below. It is believed that the larger the distance between the membrane anode and the cathode is, the more power would be consumed, while the disinfection effect may be stronger. However, this distance can be scaled up or down based on the size of the tank, the anode, the cathode, etc. The separators are typically made of non-conductive materials. In some embodiments, the separators are rubbers. The tank can be made of any suitable materials such as plastic, glass, or polymer materials (i.e. poly(methyl methacrylate) or polycarbonate, that provide sufficient strength. Additional ports can be drilled into or otherwise provided on the wall(s) of the tank at defined locations to serve as inlet and/or outlet for supplying and removing water from the tank respectively.

B. Membrane Anode

The membrane anode disclosed herein contains a carbon-based material. Any carbon-based material can be used in the membrane anode. Exemplary carbon-based materials are conducting polymers (in the form of films or fibers) carbon cloth, carbon paper, carbon screen printed electrodes, carbon paper, carbon black, carbon powder, carbon fiber, singe-walled carbon nanotubes, double-walled carbon nanotubes, multi-walled carbon nanotubes, carbon nanotube arrays, diamond-coated conductors, glassy carbon and mesoporous carbon. In addition, other exemplary carbon-based materials are graphene, graphite, uncompressed graphite worms, delaminated purified flake graphite, high performance graphite and carbon powders, highly ordered pyrolytic graphite, pyrolytic graphite, and polycrystalline graphite. In some embodiments, the carbon-based material is carbon powder, carbon fiber, carbon fabric, or a combination thereof. In a preferred embodiment, the carbon-based material is an activated carbon material in any suitable forms, such as activated carbon powder, activated carbon fiber, activated carbon fabric, or a combination thereof. In a particular embodiment, the carbon-based material is an activated carbon fiber made into woven or non-woven fabrics, i.e. activated carbon fiber cloth (ACFC).

The ACFC has a high surface area containing a plurality of pores. In some embodiments, the membrane anode containing carbon-based material has a surface area at least 10 m²/g, at least 100 m²/g, at least 500 m²/g, at least 1000 m²/g, up to 2000 m²/g, up to 5000 m²/g, between 100 m²/g and 5000 m²/g, between 1000 m²/g and 5000 m²/g, or between 1000 m²/g and 2000 m²/g inclusive. ACFC is hydrophobic and microporous designed for adsorption function, enabling ACFC in the disclosed REM system to absorb pathogens and conducts electricity, functioning as both a filter membrane and anodic electrode. In some embodiments, the pores have a diameter between 1 nm and 1 mm to achieve both micro- and ultrafiltration.

In specific embodiments, the ACFC is ZORFLEX®.

The membrane anode can contain one or more than one layer of the carbon-based material, such as between 1 layer and 100 layers of the carbon-based material (see, for example, FIG. 1A, 102). In some embodiments, the membrane anode contains at least or exactly one layer of the carbon-based material. In some embodiments, the membrane anode contains more than one layer of the carbon-based material. For example, the membrane anode contains at least or exactly 2, at least or exactly 3, at least or exactly 4, at least or exactly 5, at least or exactly 6, at least or exactly 8, at least or exactly 10, at least or exactly 12, at least or exactly 15, at least or exactly 20 layers, or at least 100 layers, such as between 2 layers and 100 layers, between 2 layers and 90 layers, between 2 layers and 80 layers, between 2 layers and 70 layers, between 2 layers and 60 layers, between 2 layers and 50 layers, between 2 layers and 40 layers, between 2 layers and 30 layers, between 2 layers and 20 layers, between 2 layers and 15 layers, or between 2 layers and 10 layers of the carbon-based material, such as 2, 4, 8, 10, 15, or 20 layers, or any other specific integer number of layers between 1 and 100, or range of two integers there between, inclusive. The number of layers of the carbon-based material can affect the liquid (e.g., water) disinfection performance of the REM system. Generally, the disinfection effect increases with the increase of the number of layers of the carbon-based material, but would limit water flow. In a preferred embodiment, at least two, three, four, five, six, seven, eight, or more layers of the carbon-based material is used in the membrane anode. In a particularly preferred embodiment, four or more layers of ACFC are used in the membrane anode. The increase in ACFC layers can promoted ROS (e.g., .OH) production and thus enhance disinfection performance. In addition, more ACFC layers can increase bacterial retention and thus contact time on the anode, therefore also enhance disinfection.

Optionally, the membrane anode contains carbon-based material and another conductive material such as a polymeric conductor, a metallic conductor, a semiconductor, a metal oxide, a modified conductor, or a combination thereof. Suitable conductors include but are not limited to gold, chromium, platinum, iron, nickel, copper, silver, stainless steel, mercury, tungsten and other metals suitable for electrode construction. The metallic conductor can be a metal alloy which is made of a combination of metals disclosed above. In addition, conductive substrates which are metallic conductors can be constructed of nanomaterials made of gold, cobalt, diamond, and other suitable metals.

Suitable semiconductors are prepared from silicon and germanium, which can be doped (i.e., the intentional introduction of impurities into an intrinsic semiconductor for the purpose of modulating its electrical and structural properties) with other elements. The semiconductors can be doped with phosphorus, boron, gallium, arsenic, indium or antimony, or a combination thereof.

Other conductive material can be metal oxides, metal sulfides, main group compounds, and modified materials. Exemplary conductive material of this type are nanoporous titanium oxide, tin oxide coated glass, cerium oxide particles, molybdenum sulfide, boron nitride nanotubes, aerogels modified with a conductive material such as gold, solgels modified with conductive material such as carbon, ruthenium carbon aerogels, and mesoporous silicas modified with a conductive material such as gold. In some embodiments, the conductive material is a mixed metal oxide.

The conductive material may contain one or more conducting materials. In embodiments where the conductive material containing two or more conducting materials, the first conducting material can be a conducting polymer and a second conducting material can be a material disclosed above. The conducting polymers include but are not limited to poly(fluorine)s, polyphenylenes, polypyrenes, polyazulenes, polynaphthalenes, poly(pyrrole)s, polycarbozoles, polyindoles, polyzaepines, polyanilines, poly(thiophene)s, poly(3,4-ethylenedioxythiophene), poly(p-phenylene sulfide), poly(acetylene)s, poly(p-phenylene vinylene), and polyimides. The second conducting material can be sputter coated on top of the conducting polymer, and the aggregate of the two makes up the conductive substrate.

C. Conductive Contactor and Cathode

The conductive contactor is typically in direct contact with the membrane anode to pass energy to the membrane anode. The cathode is placed apart from the membrane anode and is in electrical connection with the conductive contactor. The conductive contactor and the cathode can be arranged in any suitable position as long as the conductive contactor is in contact with the membrane anode and the cathode is separated from the membrane anode. In some embodiments, the conductive contactor, the membrane anode, and the cathode are arranged in parallel to each other wherein the conductive contactor contacts the membrane anode. The conductive contactor and the cathode can have any suitable shapes, i.e. in the form of individual plates, circles, squares, or grids. In a preferred embodiment, the conductive contactor and/or the cathode is a plurality of grids (see, for example, FIG. 1A, 103 and 104).

A voltage is applied between the conductive contactor and the cathode, resulting a voltage on the membrane anode to drive the water oxidation reaction. Generally, any conductive material described above can be used as conductive contactor and cathode. The conductive contactor and cathode can be the same conductive material or different conductive materials. In a preferred embodiment, the conductive contactor and the cathode are both mixed metal oxide.

### III. Methods of Making the Reactive Electrochemical Membrane System

REM systems disclosed herein typically include a tank, a membrane anode, a cathode, and a conductive contactor. The conductive contactor is in contact, preferably direct contact, with the membrane anode. The conductive contactor is in electrical communication with the cathode. The REM system can further contain an inlet and an outlet. Optionally, a reference electrode can be included in the REM system and placed at a close distance to the membrane anode. In the most preferred embodiment, the REM system has a configuration as shown in FIG. 1A.

The membrane anode, the cathode, and the conductive contactor can be housed in a single compartment within the same tank or in separate compartments within the same tank, or separate tanks that are electrochemically connected. The membrane anode and the cathode are typically in the same compartment, or in separate compartments within the same tank, or separate tanks that are electrochemically connected, and placed apart to avoid shorts. In some embodiments, separators are included in the REM system to keep a distance between the membrane anode and the cathode. The above identified elements can be arranged in any suitable positions as long as the membrane anode and the conductive contactor are in contact and the membrane anode and the cathode are placed separately.

In a preferred embodiment, (ZORFLEX®) from CalgonCarbon (Pittsburgh, Pa.) is utilized at a single weave ACFC. ZORFLEX® has a large surface area of 1,000-2,000 m²/g as a highly microporous material, although its geometric area is only about 6.67×10⁻³ m²/g. In the Examples below, the cloth was cut into circular pieces (3-cm diameter) to fit in the REM filtration device that was custom-made and set up as indicated in FIG. 1A. The effective flow cross section area is 7.07×10⁻⁴ m². DC power was supplied to the REM device using a 303DM DC power supply (Electro Industries Inc., Monticello, Minn., USA) in constant voltage mode with the ACFC placed in contact with a mixed metal oxide (MMO) grid as the anode and another MMO grid in parallel as the cathode. A ring-shaped rubber separator of 1.25 cm thickness placed between the anode and cathode. The MMO grid was made of titanium coated with iridium-ruthenium oxide, which is known as a dimensionally stable anode (DSA) material and has been widely used in water treatment applications (Rao, et al., Environmental Science and Pollution Research 2014, 21, 3197-3217; Kenova, et al., Environmental Science and Pollution Research 2018, 25, 30425-30440). The MMO grids were used in the REM device as a contactor on anode and as the cathode because of their good conductivity and stability.

It will be appreciated, however, the system utilized in the working Examples and described in the paragraph above, is exemplary in nature, and the REM system can be increased or decreased in size and scale, and components can be substituted as described herein depending on the particular use or need.

### IV. Methods of Using the Reactive Electrochemical Membrane System

One of the various aspects of the disclosed REM system is a method of disinfecting a liquid such as water. The REM system can be used for treating water to reduce the amount of living microbes, particularly pathogens, such as E. coli. In some embodiments, the method of using the REM system contains the steps of: (a) introducing the liquid into a reactive electrochemical membrane system; (b) passing the water through the membrane anode; and optionally (c) removing the disinfected water from the reactive electrochemical membrane system, wherein the reactive electrochemical membrane system comprises a tank into which water is introduced; a membrane anode in the tank which comprises a carbon-based material; a cathode in the tank; and a conductive contactor, wherein the conductive contactor is in contact with the membrane anode, and wherein the conductive contactor is in electrical communication with the cathode. The REM can operate at room temperature for disinfecting the liquid, and it can also be operated at temperatures below room temperature. For example, during disinfection, the liquid and the reactive electrochemical membrane system are at room temperature or a temperature that is below the room temperature.

Optionally, the method further includes a step of applying a voltage between the conductive contactor and the cathode prior to step (a), during (i.e. simultaneously with or substantially simultaneously with) step (a), prior to step (b), or during step (b), and maintaining the voltage until all liquid has passed through the membrane anode. The voltage applied is typically at least 1 V, 2 V, 3 V, 4 V, 5 V, 6 V, 7 V, 8 V, 9 V, or 10 V, such as at least 2 V or at least 10 V. Typically, the membrane anode oxidizes the liquid to generate reactive oxygen species during step (b).

The liquid can be introduced into the tank at a flow rate 0.1 mL/min and 10,000 mL/min inclusive, or any sub-range there between or any specific flow rate between rounded to the nearest tenth. For example, in some embodiments, the flow rate is between 0.1 mL/min and 9,000 mL/min, between 0.1 mL/min and 8,000 mL/min, between 0.1 mL/min and 7,000 mL/min, between 0.1 mL/min and 6,000 mL/min, between 0.1 mL/min and 5,000 mL/min, between 0.1 mL/min and 4,000 mL/min, between 0.1 mL/min and 3,000 mL/min, between 0.1 mL/min and 2,000 mL/min, between 0.1 mL/min and 1,000 mL/min, between 0.1 mL/min and 900 mL/min, between 0.1 mL/min and 800 mL/min, between 0.1 mL/min and 700 mL/min, between 0.1 mL/min and 600 mL/min, between 0.1 mL/min and 500 mL/min, between 0.1 mL/min and 400 mL/min, between 0.1 mL/min and 300 mL/min, between 0.1 mL/min and 200 mL/min, between 0.1 mL/min and 100 mL/min, between 10 mL/min and 2,000 mL/min, between 10 mL/min and 1,000 mL/min, between 10 mL/min and 500 mL/min, between 1 mL/min and 200 mL/min, between 1 mL/min and 500 mL/min, between 1 mL/min and 1,000 mL/min, between 1 mL/min and 2,000 mL/min, between 1 mL/min and 5000 mL/min, between 1 mL/min and 10,000 mL/min, between 0.1 mL/min and 20 mL/min, between 1 mL/min and 20 mL/min, between 0.1 mL/min and 15 mL/min, between 1 mL/min and 15 mL/min, between 0.1 mL/min and 10 mL/min, between 1 mL/min and 100 mL/min, or between 1 mL/min and 10 mL/min, inclusive. In some embodiments, the flow rate is between 10 mL/min and 2,000 mL/min, 1 mL/min and 100 mL/min, 1 mL/min and 20 mL/min or between 1 mL/min and 10 mL/min inclusive. In some embodiments, the flow rate is between 0.1 mL/min and 100 mL/min, between 0.1 mL/min and 20 mL/min, between 1 mL/min and 20 mL/min inclusive, or 1, 2, 3, 4, 5, 6, 7, 8, 9, 10, 11, 12, 13, 14, 15, 16, 17, 18, 19, or 20 ml/min. Typically, the flow rate of water does not reduce the disinfecting ability of the system relative to a lower flow rate. The flow rates can be scaled up or down based on the size of the tank, the anode, the cathode, etc. In some embodiments, preferably the flow rate is sufficient to maximize microbial reduction relative to lower or higher flow rates. In some embodiments, the flow rate is as high as possible without substantially reducing the antimicrobial activity of the system.

Optionally, the method further includes a step of adding one or more electrolytes and/or one or more ROS generating reactants into the liquid prior to step (a) to increase the conductivity of liquid and or to provide additional ROS.

Typically, the reduction of living microbes in the liquid is at least 1 log unit, at least 1.5 log units, at least 2 log units, at least 2.5 log units, at least 3 log units, at least 3.5 log units, at least 4 log units, at least 4.5 log units, at least 5 log units, at least 5.5 log units, at least 6 log units, at least 6.5 log units, at least 7 log units, or up to 7.5 log units relative to when the liquid was introduced into the system.

The disclosed REM systems are advantageous because they can be constructed to require a smaller volume and occupy a smaller footprint than traditional water treatment systems, making them portable systems for point-of-care water treatment, i.e., point-of-care water treatment in rural or developing regions. Additionally, the energy consumption of the disclosed REM systems can be extremely low making them operable with solar power. In a preferred embodiment, a REM system is fabricated using (a) ACFC as membrane anode, (b) mixed metal oxide as conductive contactor and cathode. REM system employing these components have demonstrated energy consumption as low as 0.0015 kWh/L. At least 2.2 kWh/L energy was required for above 2 log units reduction of E. coli in previous report (Racyte, et al., Water Res. 2013, 47, 6395-6405). The disclosed REM system can be powered by solar energy.

In addition, the Examples show the REM system shows superior disinfection efficiency, i.e., a reduction of up to 7.5 log unit of pathogen in disinfected water. The performance of the REM system is stable for at least 4 hours under continuous operation with water passing through the membrane anode without membrane fouling, i.e. no significant bacteria growth occurs on the membrane anode within 4 h of operation. In some embodiments, the REM systems can treat 1.5 L of water that is estimated to be the daily consumption of drinking water for an adult within 1.5 minutes, within 1 min, within 55 seconds, within 50 seconds, within 45 seconds, within 40 seconds, within 35 seconds, within 30 seconds, within 25 seconds, within 20 seconds, within 15 seconds, within 10 seconds, or within 5 seconds.

A. Sources of Liquid for Disinfection

The disclosed systems are typically used to reduce or remove microbes from a liquid. The liquid can be, for example environmental media, e.g. groundwater, fresh water, sea water, rain water, or surface water or water from man-made environments such as domestic wastewater, medical wastewater, urine, agricultural wastewater, industrial wastewater, or cooling tower wastewater.

The disclosed methods can be generally classified as in situ or ex situ. In situ disinfection involves treatment at the contaminated site or location, while ex situ involves the removal of the contaminated material to be treated elsewhere. A typical disinfection method includes passing a liquid in need of disinfection to reduce the presence of living microbes in the liquid relative to when the liquid entered the system in an effective amount to be suitable for its intended purpose (e.g., one or more of human contact, human consumption, cooking, bathing, irrigation, cooling tower, industrial use, discharge, groundwater injection etc.).

Sites or locations in need of disinfection are not restricted, although typically such sites or locations include, but are not limited to, groundwater, aquifers, surface water courses, subsurface water courses, and liquid from costal and marine environments.

B. Microbes

The disclosed systems and method can be used to kill and/or remove microbes (also referred to as microorganisms) from a liquid. The microbes can be pathogen, non-pathogenic, or a combination thereof. The microbes can be, but are not limited to, bacteria, protozoa, etc. Preferably, the systems and methods can reduce the number of living microbes, or at least living pathogenic microbes, in an effective amount for the liquid to be used for it intended purpose, e.g., create convert undrinkable water to drinkable water, and/or other uses such as bathing, cooking, etc.)

Example microbes include, but are not limited to, Actinomyces, Anabaena, Bacillus, Bacteroides, Bdellovibrio, Bordetella, Borrelia, Campylobacter, Caulobacter, Chlamydia, Chlorobium, Chromatium, Clostridium, Corynebacterium, Cytophaga, Deinococcus, Escherichia, Francisella, Halobacterium, Heliobacter, Haemophilus, Hemophilus influenza type B (HIB), Hyphomicrobium, Legionella, Leptspirosis, Listeria, Meningococcus A, B and C, Methanobacterium, Micrococcus, Myobacterium, Mycoplasma, Myxococcus, Neisseria, Nitrobacter, Oscillatoria, Prochloron, Proteus, Pseudomonas, Phodospirillum, Rickettsia, Salmonella, Shigella, Spirillum, Spirochaeta, Staphylococcus, Streptococcus, Streptomyces, Sulfolobus, Thermoplasma, Thiobacillus, and Treponema, Vibrio, Yersinia, Cryptococcus neoformans, Histoplasma capsulatum, Candida albicans, Candida tropicalis, Nocardia asteroides, Rickettsia ricketsii, Rickettsia typhi, Mycoplasma pneumoniae, Chlamydial psittaci, Chlamydial trachomatis, Plasmodium falciparum, Trypanosoma brucei, Entamoeba histolytica, Toxoplasma gondii, Trichomonas vaginalis and Schistosoma mansoni.

Additional microbes include, but are not limited to, virus such as Norovirus and Coronavirus.

Escherichia coli, for example, is one of the major enteric pathogens that cause severe diseases (Ashbolt, Toxicology 2004, 198, 229-238).

The disclosed devices, systems, compositions, and methods can be further understood through the following numbered paragraphs.

1. A reactive electrochemical membrane system for disinfecting liquid comprising:

a tank;

a membrane anode in the tank which comprises a carbon-based material;

a cathode in the tank; and

a conductive contactor,

wherein the conductive contactor is in direct contact with the membrane anode, and wherein the conductive contactor is in electrical communication with the cathode.

2. The reactive electrochemical membrane system of paragraph 1, wherein the membrane anode comprises a porous membrane.

3. The reactive electrochemical membrane system of paragraph 2, wherein the porous membrane comprises a plurality of pores, and wherein the size of the pores is between 1 nm and 1 mm.

4. The reactive electrochemical membrane system of any one of paragraphs 1-3, wherein the membrane anode has a surface area between 10 m²/g and 5000 m²/g.

5. The reactive electrochemical membrane system of any one of paragraphs 1-4, wherein the carbon-based material is an activated carbon material.

6. The reactive electrochemical membrane system of paragraph 5, wherein the activated carbon material is an activated carbon fiber.

7. The reactive electrochemical membrane system of paragraph 6, wherein the activated carbon fiber is in the form of activated carbon fiber cloth.

8. The reactive electrochemical membrane system of any one of paragraphs 1-7, wherein the membrane anode comprises one or more layers of the carbon-based material.

9. The reactive electrochemical membrane system of any one of paragraphs 1-8, wherein the membrane anode comprises at least four layers of the carbon-based material.

10. The reactive electrochemical membrane system of any one of paragraphs 1-9, wherein the liquid further comprises an electrolyte.

11. The reactive electrochemical membrane system of any one of paragraphs 1-10 further comprising separators placed between the membrane anode and the cathode.

12. The reactive electrochemical membrane system of paragraph 11, wherein the separators comprise rubber.

13. The reactive electrochemical membrane system of any one of paragraphs 1-12, wherein the tank comprises an inlet configured to supply liquid into the tank and an outlet configured to remove liquid from the tank after liquid passes through the membrane anode.

14. The reactive electrochemical membrane system of any one of paragraphs 1-13 further comprising a pump arranged to supply liquid into the tank.

15. The reactive electrochemical membrane system of any one of paragraphs 1-14, wherein the membrane anode, the cathode, and the conductive contactor are arranged in parallel to each other.

16. The reactive electrochemical membrane system of any one of paragraphs 1-15, wherein the conductive contactor and/or the cathode is in the form of grids.

17. The reactive electrochemical membrane system of any one of paragraphs 1-16, wherein the conductive contactor and/or the cathode is mixed metal oxide.

18. The reactive electrochemical membrane system of any one of paragraphs 1-17, wherein a voltage is applied between the conductive contactor and the cathode.

19. The reactive electrochemical membrane system of any one of paragraph 1-18, wherein the voltage is at least 2 V, 3 V, 4 V, 5 V, 6 V, 7 V, 8 V, 9 V, or 10 V.

20. The reactive electrochemical membrane system of paragraph 18, wherein the voltage is 10 V.

21. The reactive electrochemical membrane system of any one of paragraphs 1-20, further comprising a liquid, wherein the liquid is introduced into the tank at a flow rate between 0.1 mL/min and 100 mL/min, or between 0.1 mL/min and 20 mL/min, or between 1 mL/min and 20 mL/min, or 1, 2, 3, 4, 5, 6, 7, 8, 9, 10, 11, 12, 13, 14, 15, 16, 17, 18, 19, or 20 ml/min.

22. The reactive electrochemical membrane system of paragraph 21, wherein the liquid is introduced into the tank at a flow rate that does not reduce the disinfecting ability of the system relative to a lower flow rate.

23. The reactive electrochemical membrane system of any one of paragraphs 21-22, wherein the membrane anode is capable of oxidizing the liquid to generate reactive oxygen species.

24. The reactive electrochemical membrane system of paragraph 23, wherein the redox oxygen species comprises hydroxyl radicals.

25. The reactive electrochemical membrane system of any one of paragraphs 21-24, wherein the liquid comprises microbes, and the system reduces the presence of living microbes in the liquid relative to when the liquid entered the system.

26. The reactive electrochemical membrane system of paragraph 25, wherein at least some of the microbes are pathogens such as E. coli.

27. The reactive electrochemical membrane system of paragraphs 25 or 26, wherein the reduction of microbes is up to 7.5 log unit relative to when the liquid was introduced into the system.

28. The reactive electrochemical membrane system of paragraph 27, wherein the liquid and the system are at room temperature.

29. The reactive electrochemical membrane system of any one of paragraphs 1-28, wherein the unit energy consumption of the system is 0.0015 kWh/L.

30. The reactive electrochemical membrane system of any one of paragraphs 1-29, wherein the system can operate continuously for at least 4 hours.

31. The reactive electrochemical membrane system of any one of paragraphs 1-30, wherein the system can be powered by solar energy.

32. The reactive electrochemical membrane system of any one of paragraphs 1-31, wherein the system can be utilized as a portable system for disinfecting water.

33. A method of disinfecting liquid comprising the steps of:

(a) introducing liquid through the inlet of a reactive electrochemical membrane system of any one of paragraphs 1-32;

(b) passing the liquid through the membrane anode; and

(c) removing the disinfected liquid through the outlet.

34. The method of paragraph 33, wherein the system reduces the number of microbes in the liquid in an effective amount to make the liquid suitable for human consumption.

35. The system of any one of paragraphs 21-32 or the method of paragraphs 33 or 34 wherein the liquid is water.

36. A reactive electrochemical membrane system for disinfecting a liquid comprising:

a tank;

a membrane anode in the tank comprising a carbon-based material;

a cathode in the tank; and

a conductive contactor,

wherein the conductive contactor is in direct contact with the membrane anode and the conductive contactor is in electrical communication with the cathode.

37. The reactive electrochemical membrane system of paragraph 36, wherein the membrane anode comprises a porous membrane comprising a plurality of pores having a diameter between 1 nm and 1 mm.

38. The reactive electrochemical membrane system of any one of paragraphs 36-37, wherein the membrane anode has a surface area between 10 m²/g and 5000 m²/g.

39. The reactive electrochemical membrane system of any one of paragraphs 36-38, wherein the carbon-based material is activated carbon fiber cloth.

40. The reactive electrochemical membrane system of any one of paragraphs 36-39, wherein the membrane anode comprises one or more layers of the carbon-based material.

41. The reactive electrochemical membrane system of any one of paragraphs 36-40, wherein the conductive contactor and/or the cathode is mixed metal oxide.

42. The reactive electrochemical membrane system of any one of paragraphs 36-41, wherein the membrane anode, the cathode, and the conductive contactor are arranged in parallel to each other.

43. The reactive electrochemical membrane system of any one of paragraphs 36-42, wherein the conductive contactor and/or the cathode is in the form of grids.

44. The reactive electrochemical membrane system of any one of paragraphs 36-43 further comprising one or more non-conductive separators placed between the membrane anode and the cathode.

45. The reactive electrochemical membrane system of any one of paragraphs 36-44, wherein the tank comprises an inlet configured to supply liquid into the tank and an outlet configured to remove liquid from the tank after liquid passes through the membrane anode.

46. The reactive electrochemical membrane system of any one of paragraphs 36-45 further comprising a pump arranged to supply liquid into the tank.

47. The reactive electrochemical membrane system of any one of paragraphs 36-46, wherein the system has a unit energy consumption less than 2 kWh/L.

48. A method of disinfecting a liquid to reduce the presence of living microbes comprising the steps of:

(a) introducing liquid into the reactive electrochemical membrane system of any one of paragraphs 36-47; and

(b) passing the liquid through the membrane anode.

49. The method of paragraph 48, further comprising a step of applying a voltage between the conductive contactor and the cathode prior to step (a), during step (a), prior to step (b), or during step (b), and maintaining the voltage.

50. The method of any one of paragraphs 48-49, wherein the membrane anode oxidizes the liquid to generate reactive oxygen species.

51. The method of any one of paragraphs 48-50, wherein the voltage is at least 2 V.

52. The method of any one of paragraphs 48-51, wherein the liquid is introduced into the tank at a flow rate between 0.1 mL/min and 10,000 mL/min, or between 10 mL/min and 2,000 mL/min, or between 1 mL/min and 100 mL/min, or between 0.1 mL/min and 20 mL/min, or between 1 mL/min and 20 mL/min, or between 1 mL/min and 10 mL/min, or 1, 2, 3, 4, 5, 6, 7, 8, 9, 10, 11, 12, 13, 14, 15, 16, 17, 18, 19, or 20 ml/min.

53. The method of any one of paragraphs 48-52, wherein the living microbes comprise E. coli.

54. The method of any one of paragraphs 48-53, wherein the reduction of the living microbes in the liquid is up to 7.5 log unit relative to when the liquid was introduced into the system.

55. The method of any one of paragraphs 48-54, wherein the liquid and the reactive electrochemical membrane system are at room temperature or a temperature that is below the room temperature.

The present invention will be further understood by reference to the following non-limiting examples.

### EXAMPLES

It is demonstrated for the first time the use of activated carbon fiber cloth (ACFC) as the membrane in a REM system to disinfect pathogens in water using non-pathogenic E. coli as a model bacterium. This effective REM system is easy to operate, environmental friendly, and displays improved performance such as significantly lowered energy consumption, superior disinfection efficiency, high disinfection speed, and reduced fabrication cost. The extremely low energy consumption make it operable with solar energy.

### Example 1. REM Using ACFC as Membrane Effectively Reduces E. coli Concentration

Materials and Methods

The experiment was conducted by passing a solution inoculated with E. coli (ATCC 15597) through a REM device with multiple layers of ACFC as the anode to which voltage was applied. Bacteria concentration was determined by plating the effluent and counting the colonies formed after incubation. Single weave ACFC (Zorflex®) was from CalgonCarbon (Pittsburgh, Pa.), and has a large surface area of 1,000-2,000 m²/g as a highly microporous material, although its geometric area is only about 6.67×10⁻³ m²/g. The cloth was cut into circular pieces (3-cm diameter) to fit in the REM filtration device that was custom-made (FIG. 1B) and set up as indicated in FIG. 1A. The effective flow cross section area is 7.07×10⁻⁴ m². DC power was supplied to the REM device using a 303DM DC power supply (Electro Industries Inc., Monticello, Minn., USA) in constant voltage mode with the ACFC placed in contact with a mixed metal oxide (MMO) grid as the anode and another MMO grid in parallel as the cathode, with a ring-shaped rubber separator of 4.25 cm thickness placed between the anode and cathode. The MMO grid is made of titanium coated with iridium-ruthenium oxide, which is known as a dimensionally stable anode (DSA) material and has been widely used in water treatment applications (Rao, et al., Environmental Science and Pollution Research 2014, 21, 3197-3217; Kenova, et al., Environmental Science and Pollution Research 2018, 25, 30425-30440). The MMO grid was used in the REM device as a contactor on anode and as the cathode because of its good conductivity and stability. All materials involved in REM treatment, including the components in the REM device, silicon tubing, and a flask as the feed tank were autoclaved at 121° C. for 30 mM prior to each disinfection experiment.

For disinfection experiment, E. coli was inoculated at approximately 10⁷ cells/mL in a solution of 50-mM Na₂SO₄ as the supporting electrolyte. The E. coli solution was freshly prepared by first mixing the culture in LB medium at 37° C. overnight and then diluting it to the desired concentration with a 50 mM Na₂SO₄ solution prepared using deionized (DI) water with a resistivity of <18 MΩ cm (Barnstead NANOpure water purification system, Waltham, Mass., USA). The solution was then placed in a feed tank and pumped through the REM device via silicon tubing at a prescribed flow rate (1-20 ml/min) using a Masterflex L/S peristaltic pump (Cole Parmer, Vernon Hills, Ill., USA), while a voltage (0-20 V) was applied to the device.

After the first 5.0 mL of effluent has passed through, a sample was collected in sterilized tube for E. coli concentration determination. All the disinfection treatments were carried out at room temperature, and activated carbon fiber cloth was replaced prior to each new test to ensure consistent results. The solution was then placed in a feed tank and pumped through the REM device via silicon tubing at a prescribed flow rate (1-20 mL/min) using a Masterflex L/S peristaltic pump (Cole Parmer, Vernon Hills, Ill., USA), while a voltage (0-20 V) was applied to the device. After the first 5.0 mL of effluent was passed through, a sample was collected in a sterilized tube for E. coli concentration determination. All the disinfection treatments were carried out at room temperature, and the activated carbon fiber cloth was replaced prior to each new test to ensure consistent results.

The E. coli samples before and after disinfection treatment were serially diluted using 0.9% sterilized NaCl solution and then 0.1 mL of the diluted sample was plated on LB agar plate. The plate was covered with parafilm and incubated at 37° C. for about 24-hr, and then the number of colonies on the agar plate was counted to calculate the colony forming unit per mL (CFU/mL) for each sample (Okochi, et al., Appl. Microbiol. Biot. 1997, 47, 18-22).

Results

Activated carbon fiber (ACF) is a form of processed carbon that is hydrophobic and microporous designed for adsorption function (Prajapati, et al., Chemosphere 2016, 155, 62-69). These properties allow ACF to adsorb bacteria, and it conducts electricity, thus enabling it usable as a membrane electrode in REM applications, as demonstrated in the results of this study. ACF is a widely available material, cheaper and easier to produce than carbon nanotubes, and is environmentally benign. ACF can be easily made into woven or nonwoven fabrics, such as the activated carbon fiber cloth (ACFC). Unlike carbon nanotubes, ACFC can be easily handled and used as membrane to achieve controllable flow conditions. A nearly 7.5 log unit reduction in E. coli concentration can be achieved by the REM treatment in this study using ACFC as the membrane. This is better than that in earlier reports with different REM membrane materials, although a direct comparison is not possible because of different treatment conditions. Near 6.5 log CFU decay was achieved for E. coli with the use of a sub-stoichiometric titanium oxide ceramic membrane in REM (Liang, et al., Water Res 2018, 145, 172-180), and only over 2 log CFU reduction was obtained for E. coli when treated by a fluidized bed electrode composed of granular activated carbon under an alternating electric field with double modulated frequency of 10 kHz & 140 kHz for 6 h (Racyte, et al., Water Res. 2013, 47, 6395-6405).

### Example 2. The Disinfection Effect of REM System is Affected by Operation Conditions

Materials and Methods

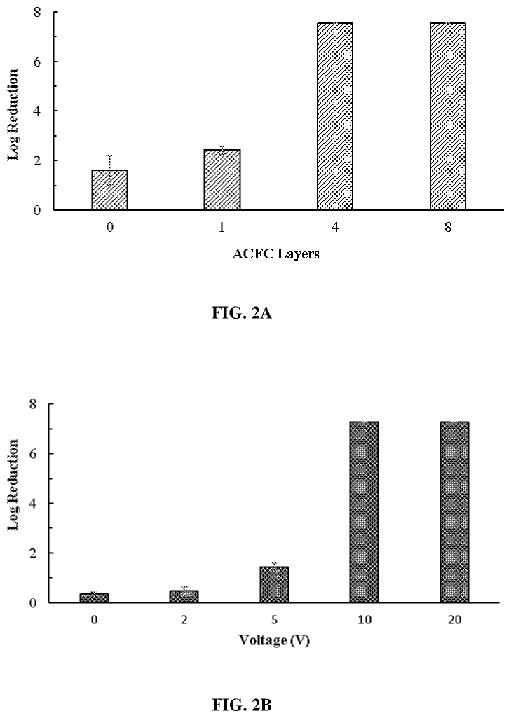

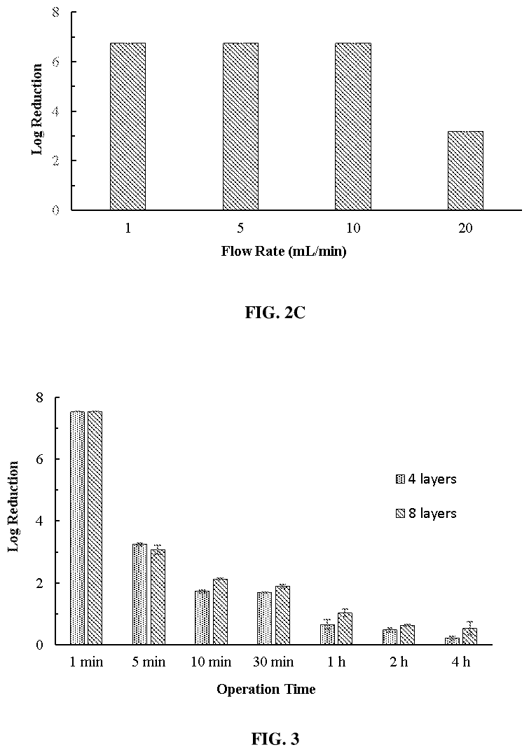

REM treatments were performed at different operation conditions including applied voltage, number of ACFC layers, flow rate, and operation time. In each set of experiments, one condition was varied and the other conditions kept constant, and the conditions that have been tested are listed in Table 1. An E. coli cell suspension of approximately 10⁷ cells/mL was passed through the REM device unless otherwise specified. Bacterial log reduction was calculated by taking the logarithm of the ratio between the bacterial concentrations in the sample before and after treatment. Each condition was tested in triplicate, for which the mean and standard deviation were calculated and shown in FIG. 2.

Results

The disinfection effect of REM treatment was evaluated with three key operating factors varied, including ACFC layers, voltage applied to the electrochemical cell, and flow rate. The conditions that have tested are summarized in Table 1, and the results are displayed in FIG. 2A-2C and also listed in Table 1. As seen in FIG. 2A, the log reduction of E. coli increased with the addition of ACFC layers from 0 to 8. There was approximately 1.6 log reduction without ACFC, 2.4 log reduction with 1 ACFC layer employed, and the log reduction of bacteria was 7.5 with both 4 layers and 8 layers, where the added E. coli were completely killed. Apparently, the disinfection effect increased with the increase of ACFC layers, while the 1.6 log reduction without ACFC may be caused by the electrochemical effect of the MMO grid. The tests demonstrated that the bacteria concentration was stable in the feed tank during the test.

The higher voltage led to an increased disinfection of the REM with four layers of ACFC (See FIG. 2B). Without any potential applied, 0.4 log reduction was observed, which could result from the retention of E. coli by ACFC layers(Guo, et al., J. Hazard. Mater. 2016, 319, 137-146). Disinfection was enhanced to 0.5, 1.4, 7.3 and 7.3 log reduction for the applied voltage of 2, 5, 10, and 20 V, respectively, where the log reduction of 7.3 represented complete disinfection. Similar phenomenon was found in an earlier study with REM using a sub-stoichiometric titanium oxide as the membrane (Guo, et al., J. Hazard. Mater. 2016, 319, 137-146).

FIG. 2C shows the effect of flow rate on the reduction of E. coli concentration in the effluent after treatment by REM with 4 ACFC layers and 10 V applied voltage. It shows that the flow rate did not impact the disinfection performance much when the flow rate was in the range of 1 to 10 mL/min, with the log reduction remaining at 6.7 for the flow rate of 1, 5, and 10 mL/min, respectively, where all the added E. coli were killed. When the flow rate increased to 20 mL/min, the disinfection performance was reduced to 3.2 log reduction. The flow rate of 10 mL/min corresponds to a linear flow velocity of 2.4×10⁻⁴ m/s with a 7.07×10⁻⁴ m² effective flow cross-section area. For a REM device with an effective cross-section area of 7.07×10⁻² m², it takes only 1.5 minutes to treat 1.5 L of water that is estimated to be daily consumption of drinking water for an adult (McCartney, BMJ: British Medical Journal (Online) 2011, 343).

TABLE 1
The conditions of REM treatment experiments and the results of
bacterial log reduction. The conditions that were varied in
each test series are represented in bold.

| | | Flow rate | Log | Standard |
|---|---|---|---|---|
| ACFC layers | Voltage (V) | (mL/min) | reduction | deviation |
| 0 | 10 | 10 | 1.61 | 0.59 |
| 1 | 10 | 10 | 2.42 | 0.15 |
| 4 | 10 | 10 | 7.53 | 0.00 |
| 8 | 10 | 10 | 7.53 | 0.00 |
| 4 | 0 | 10 | 0.35 | 0.06 |
| 4 | 2 | 10 | 0.47 | 0.16 |
| 4 | 5 | 10 | 1.43 | 0.17 |
| 4 | 10 | 10 | 7.28 | 0.00 |
| 4 | 20 | 10 | 7.28 | 0.00 |
| 4 | 10 | 1 | 6.74 | 0.00 |
| 4 | 10 | 5 | 6.74 | 0.00 |
| 4 | 10 | 10 | 6.74 | 0.00 |
| 4 | 10 | 20 | 3.18 | 0.01 |

### Example 3. The REM System Demonstrates Continuous Operation for at Least 4 h

Materials and Methods

REM was operated continuously with a total of 2.4 L E. coli solution treated using 10 V voltage (applied to the electrochemical cell) at a flow rate of 10 mL/min with 4 or 8 layers of ACFC, and the effluent were collected at different time intervals to measure the change of E. coli concentration over time. Each condition was tested in triplicate, for which the mean and standard deviation were calculated and shown in FIG. 3.

Results

The disinfection efficiency decreased over time for both 4 and 8 layers during the continuous operation as shown in FIG. 3, with the performance of 8 layers slightly better than that of 4 layers. This is possibly due to the gradual accumulation of cells on ACFC, preventing more E. coli from contact and thus limiting the electrochemical disinfection effect. During the test, samples have been taken from the feed tank to measure E. coli concentration, and the result showed that no observable bacterial growth or decay occurred in the feed tank within the 4 h of operation.

### Example 4. The REM System Demonstrates Low Energy Consumption

Materials and Methods

Unit energy consumption (UEC) is defined as the energy consumption per unit volume per log reduction of E. coli, which can be calculated by equation 1.

$$UEC = \frac{E}{Vl} = \frac{\text{?}}{60 rl} \\ \text{?} \text{indicates text missing or illegible when filed} \qquad ( 1 )$$

Where E represents energy (kWh), V volume (L), l the log reduction of E. coli., U the applied voltage (V), I the electric current (A) and r the flow rate (mL/min) for the treatment.

Results

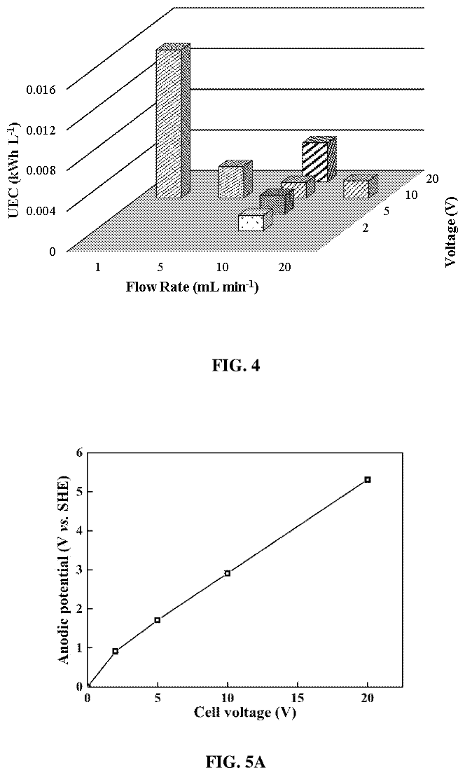

Energy input is an important factor when considering effectiveness for application. The unit energy consumption (UEC), defined as the energy consumption per unit volume per log reduction of E. coli, was calculated for all treatments with 4 ACFC layers shown in Table 1 and demonstrated in FIG. 4. The UEC decreased as the flow rate increased and as the applied voltage decreased. The UEC for REM treatment was found to be 0.0015 kWh/L (i.e., 1.5 kWh/m³) with 4 layers of ACFC at 10 mL/min and 10 V, which was among the conditions achieving complete bacterial disinfection as seen in FIG. 2. Such an energy consumption level shows that the ACFC-based REM can be driven by solar energy. At least a 2.2 kWh/L energy requirement has been reported for above 2 log units reduction of E. coli using the fluidized bed electrode of granular activated carbon (Racyte, et al., Water Res. 2013, 47, 6395-640).

### Example 5. The REM System Generates Reactive Oxygen Species that Disinfect Pathogens Effectively

Materials and Methods

Measurement of Anodic Potentials

REM device was immersed in 30 mL 50-mM Na₂SO₄ solution, with different voltage applied to the REM electrodes, and the anodic potential was measured versus a leak-free Ag/AgCl reference electrode (Warner Instruments, LF-100) placed 0.85 mm from the anode surface using a CHI 660E electrochemical workstation (Austin, Tex.). All potentials were reported versus the standard hydrogen electrode (SHE).

The linear scan voltammetry (LSV) analyses were conducted using ACFC as the anode, a platinum foil of the same size as the counter electrode, and a leak-free Ag/AgCl electrode as the reference electrode in 30 mL 50-mM Na₂SO₄ solution, at a scan rate of 50 mV s⁻¹ driven by the CHI 660E electrochemical workstation (Austin, Tex.).

Quantification of Hydroxyl Free Radicals

An additional experiment was performed to quantify the steady-state concentration of hydroxyl free radicals ([.OH]ss) that may be formed on the anode in the REM device, using terephthalic acid (TA) as a free radical probe. The REM device was immersed in 30 mL of a 50 mM Na₂SO₄ solution containing 10 μM TA, with 10 V applied to the REM electrodes. At prescribed time intervals (0, 5, 15, 30, 60 and 120 min), 0.5 mL samples were taken and analyzed by high performance liquid chromatography (HPLC) to quantify TA as described below.

Analytical Methods

A Shimadzu LC 20TA High Performance Liquid Chromatography (HPLC) equipped with a Shimadzu SPD-M20A Photo Diode Array (PDA) was used to quantify TA concentrations. The separation was performed on an Ascentic C18 reversed phase column (250×4 mm, 5 μm particle, Supelco) and injection volume was 10 μL. A binary solvent comprising of methanol with 0.1% formic acid and water with 0.1% formic acid was used as the mobile phase, and the flow rate was at 0.8 mL/min

Results

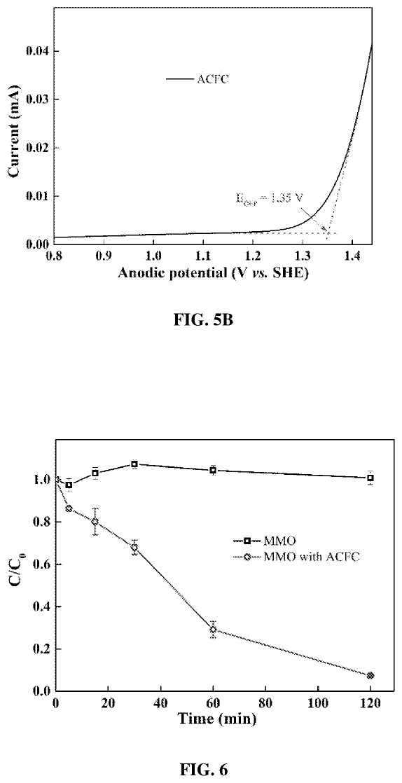

The anodic potentials of REM were measured under different applied voltages and plotted in FIG. 5A. The cell voltage of 2.0 and 5.0 V, between which the disinfection performance started to rise as shown in FIG. 2B, corresponds to the anodic potential of 0.91 and 1.71 V vs. SHE, respectively, as shown in FIG. 5A. The LSV of ACFC in 50 mM Na₂SO₄ solution (See FIG. 5B) revealed the oxygen evolution potential (OEP) to be 1.35 V vs. SHE. Therefore, the disinfection performance was promoted around the anodic potential where water oxidation reactions intensified. The anodic oxidation of water can generate hydroxyl radicals that is known to disinfect pathogens by reacting with unsaturated membrane lipids to destruct membrane structure and cell integrity to further cause cell lysis and protein release (Petersen, AIMS biophysics 2017, 4, 240). In addition to hydroxyl radicals, other reactive oxygen species (ROS) such as ozone and hydrogen peroxide may also be formed during anodic water oxidation that can disinfect pathogens albeit less effective than hydroxyl radicals (Yang, et al., Electrochemistry Communications 2018, 86, 26-29; Xie, et al., Applied Catalysis B: Environmental 2017, 203, 515-525; Bakheet, et al., Chemical Engineering Journal 2018).

The steady-state concentrations of hydroxyl radicals ([.OH]ss) that were produced in the REM system were quantified using terephthalic acid (TA) as a radical probe with 4 ACFC layers under 10 V voltage. The TA disappearance over time was plotted in FIG. 6, based on which the pseudo-first order rate constant (k_{TA}) can be obtained by data fitting. The [.OH]ss was then calculated using the following equation:

$$[ • OH ] ss = \frac{{k}_{TA}}{{k}_{• OH , TA}} \qquad ( 2 )$$

where k._{OH}, _{TA} is the second-order reaction rate constant between .OH and TA (4.4×10⁹ M⁻¹ s⁻¹). The [.OH]ss was determined as 0.8×10⁻¹³ M. In order to distinguish if the hydroxyl free radicals were generated from the ACFC or the MMO grid, the same TA probing test was conducted for the REM device without an ACFC layer in place. TA did not disappear in this system as shown in FIG. 6, and, according to equation 2, the [.OH]ss was 0 in this case. This shows that hydroxyl radicals were mainly produced by ACFC rather than the MMO grid in the REM device. The MMO grid is coated with iridium-ruthenium oxide that is known as a material facilitating anodic water oxidation without effective .OH production (Kenova, et al., Environmental Science and Pollution Research 2018, 25, 30425-30440; Brillas, et al., Applied Catalysis B: Environmental 2015, 166, 603-643). The moderate disinfection effect of REM without an ACFC layer as shown in FIG. 2 may have resulted from ROS other than .OH, such as hydrogen peroxide, that were formed during water oxidation. The increase in ACFC layers promoted .OH production and thus enhanced disinfection performance. In addition, more ACFC layers increased bacterial retention and thus contact time on the anode, therefore also enhancing disinfection.

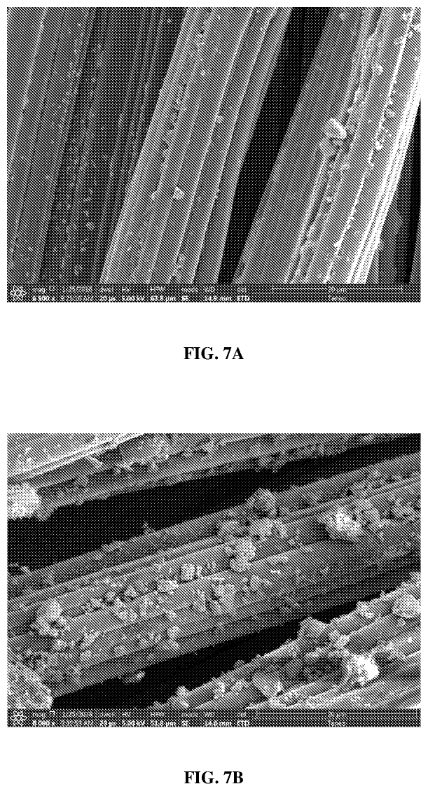

The SEM images of ACFC from REM after passing E. coli solution (10 mL/min) with or without voltage (10V) applied were obtained. The microstructure of ACFC is evident in FIG. 7A-7B. Without voltage applied, few E. coli and Na₂SO₄ crystals were found attached on the surface of ACFC (See FIG. 7A). The treatment with 10 V applied resulted in the increased attachment of E. coli remnants which might be damaged in cell structure by ROS generated on ACFC (See FIG. 7B). No intact E. coli can be found on ACFC in all pictures taken.

REM using ACFC as the membrane achieved superb reduction of E. coli (up to 7.5 log unit reduction), likely through the combined effects of retention of bacteria on ACFC and the oxidation by .OH and other ROS generated electrochemically on the anode. The disinfection effect was shown to be dependent on the number of ACFC layers, voltage, flow rate, as well as operation time. ACFC is a widely available, environmentally benign, and low-cost material. REM is a versatile, energy-efficient process that can be driven by solar energy. The results demonstrate that the ACFC-based REM process can be used for point-of-use water disinfection, particularly for rural, developing regions.

It must be noted that as used herein and in the appended claims, the singular forms “a”, “an”, and “the” include plural reference unless the context clearly dictates otherwise.

Throughout the description and claims of this specification, the word “comprise” and variations of the word, such as “comprising” and “comprises,” means “including but not limited to,” and is not intended to exclude, for example, other additives, components, integers or steps.

“Optional” or “optionally” means that the subsequently described event, circumstance, or material may or may not occur or be present, and that the description includes instances where the event, circumstance, or material occurs or is present and instances where it does not occur or is not present.

Ranges may be expressed herein as from “about” one particular value, and/or to “about” another particular value. When such a range is expressed, also specifically contemplated and considered disclosed is the range from the one particular value and/or to the other particular value unless the context specifically indicates otherwise. Similarly, when values are expressed as approximations, by use of the antecedent “about,” it will be understood that the particular value forms another, specifically contemplated embodiment that should be considered disclosed unless the context specifically indicates otherwise. It will be further understood that the endpoints of each of the ranges are significant both in relation to the other endpoint, and independently of the other endpoint unless the context specifically indicates otherwise. It should be understood that all of the individual values and sub-ranges of values contained within an explicitly disclosed range are also specifically contemplated and should be considered disclosed unless the context specifically indicates otherwise. Finally, it should be understood that all ranges refer both to the recited range as a range and as a collection of individual numbers from and including the first endpoint to and including the second endpoint. In the latter case, it should be understood that any of the individual numbers can be selected as one form of the quantity, value, or feature to which the range refers. In this way, a range describes a set of numbers or values from and including the first endpoint to and including the second endpoint from which a single member of the set (i.e. a single number) can be selected as the quantity, value, or feature to which the range refers. The foregoing applies regardless of whether in particular cases some or all of these embodiments are explicitly disclosed.

Unless defined otherwise, all technical and scientific terms used herein have the same meanings as commonly understood by one of skill in the art to which the disclosed invention belongs. Publications cited herein and the materials for which they are cited are specifically incorporated by reference.

Those skilled in the art will recognize, or be able to ascertain using no more than routine experimentation, many equivalents to the specific embodiments of the invention described herein. Such equivalents are intended to be encompassed by the following claims.

We claim:

1. A reactive electrochemical membrane system for disinfecting a liquid comprising:
a tank;
a membrane anode in the tank comprising a carbon-based material;
a cathode in the tank; and
a conductive contactor,
wherein the conductive contactor is in direct contact with the membrane anode and the conductive contactor is in electrical communication with the cathode.

2. The reactive electrochemical membrane system of claim 1, wherein the membrane anode comprises a porous membrane comprising a plurality of pores having a diameter between 1 nm and 1 mm.

3. The reactive electrochemical membrane system of claim 1, wherein the membrane anode has a surface area between 10 m²/g and 5000 m²/g.

4. The reactive electrochemical membrane system of claim 1, wherein the carbon-based material is activated carbon fiber cloth.

5. The reactive electrochemical membrane system of claim 1, wherein the membrane anode comprises one or more layers of the carbon-based material.

6. The reactive electrochemical membrane system of claim 1, wherein the conductive contactor and/or the cathode is mixed metal oxide.

7. The reactive electrochemical membrane system of claim 1, wherein the membrane anode, the cathode, and the conductive contactor are arranged in parallel to each other.

8. The reactive electrochemical membrane system of claim 1, wherein the conductive contactor and/or the cathode is in the form of grids.

9. The reactive electrochemical membrane system of claim 1 further comprising one or more non-conductive separators placed between the membrane anode and the cathode.

10. The reactive electrochemical membrane system of claim 1, wherein the tank comprises an inlet configured to supply liquid into the tank and an outlet configured to remove liquid from the tank after liquid passes through the membrane anode.

11. The reactive electrochemical membrane system of claim 1 further comprising a pump arranged to supply liquid into the tank.

12. The reactive electrochemical membrane system of claim 1, wherein the system has a unit energy consumption less than 2 kWh/L.

13. A method of disinfecting a liquid to reduce the presence of living microbes comprising the steps of:
(a) introducing liquid into the reactive electrochemical membrane system of claim 1; and
(b) passing the liquid through the membrane anode.

14. The method of claim 13, further comprising a step of applying a voltage between the conductive contactor and the cathode prior to step (a), during step (a), prior to step (b), or during step (b), and maintaining the voltage.

15. The method of claim 14, wherein the membrane anode oxidizes the liquid to generate reactive oxygen species.

16. The method of claim 14, wherein the voltage is at least 2 V.

17. The method of claim 13, wherein the liquid is introduced into the tank at a flow rate between 0.1 mL/min and 10,000 mL/min, or between 10 mL/min and 2,000 mL/min, or between 1 mL/min and 100 mL/min, or between 0.1 mL/min and 20 mL/min, or between 1 mL/min and 20 mL/min, or between 1 mL/min and 10 mL/min, or 1, 2, 3, 4, 5, 6, 7, 8, 9, 10, 11, 12, 13, 14, 15, 16, 17, 18, 19, or 20 ml/min.

18. The method of claim 13, wherein the living microbes comprise E. coli.

19. The method of claim 13, wherein the reduction of the living microbes in the liquid is up to 7.5 log unit relative to when the liquid was introduced into the system.

20. The method of claim 13, wherein the liquid and the reactive electrochemical membrane system are at room temperature or a temperature that is below the room temperature.
